(19) United States
(12) Patent Application Publication
(10) Pub. No.: US 2025/0011913 A1
(43) Pub. Date: Jan. 9, 2025

(54) ROTARY DEVICE AND THERMAL SPRAYING APPARATUS

(71) Applicant: NHK SPRING CO., LTD., Yokohama-shi (JP)

(72) Inventors: Satoshi HIRANO, Yokohama-shi (JP); Go TAKAHARA, Yokohama-shi (JP); Takatoshi NAMBU, Yokohama-shi (JP); Noriyoshi KANEDA, Yokohama-shi (JP); Hibiki YOKOYAMA, Yokohama-shi (JP); Michiyoshi SONE, Yokohama-shi (JP)

(21) Appl. No.: 18/898,406

(22) Filed: Sep. 26, 2024

Related U.S. Application Data
(63) Continuation of application No. PCT/JP2023/007341, filed on Feb. 28, 2023.

(30) Foreign Application Priority Data
Mar. 28, 2022 (JP) 2022-052502

(51) Int. Cl. C23C 4/123; B05B 13/02

(52) U.S. Cl. CPC C23C 4/123; B05B 13/0228

(57) ABSTRACT

This rotary device comprises a rotary stage detachably supporting a base material having an inlet and an outlet for a liquid at a predetermined temperature, and a flow path connecting the inlet to the outlet, a rotary support which supports a rotary stage, a rotary mechanism which rotates the rotary stage around the rotary support, and a liquid supply part which supplies the liquid to the base material. The rotary stage has a liquid supply port for supplying the liquid to the base material, and a liquid discharge port for discharging the liquid from the base material. The rotary support has therein a first pipe connected to the liquid supply port, and a second pipe connected to the liquid discharge port. In addition, the thermal spraying apparatus comprises the rotary device and a thermal spray gun.

### CROSS-REFERENCE TO RELATED APPLICATIONS

This application is a Continuation of International Patent Application No. PCT/JP2023/007341, filed on Feb. 28, 2023, which claims the benefit of priority to Japanese Patent Application No. 2022-052502, filed on Mar. 28, 2022, the entire contents of which are incorporated herein by reference.

### FIELD

An embodiment of the present disclosure relates to a rotary device and a thermal spraying apparatus.

### BACKGROUND

A thermal spraying device is known in which a film-forming material such as a metal or a ceramic is heated to be melted or brought into a state close to melting (semi-molten), and the film-forming material that is melted or brought into the semi-molten state is sprayed onto a base material, thereby forming a film of the film-forming material on a base material. For example, Japanese unexamined utility model application publication No. S58-35961 and Japanese laid-open patent publication No. S58-039772 disclose a thermal spraying device in which a workpiece is rotated, and a molten metal is adhered to a surface thereof to form a metal coating layer.

### SUMMARY

A rotary device according to an embodiment of the present disclosure comprises a rotary stage detachably supporting a base material having an inlet, an outlet, and a flow path connecting the inlet and the outlet of a liquid at a predetermined temperature, the rotary stage having a liquid supply port supplying the liquid to the base material and a liquid discharge port discharging the liquid from the base material, a rotary support supporting the rotary stage, the rotary support having a first pipe connected to the liquid supply port and a second pipe connected to the liquid discharge port inside, a rotary mechanism rotating the rotary support and a liquid supply part supplying the liquid to the base material.

A thermal spraying apparatus according to an embodiment of the present disclosure comprises the rotary device described above and a thermal spray gun.

### BRIEF DESCRIPTION OF DRAWINGS

FIG. 1 is a diagram for explaining a configuration of a thermal spraying apparatus according to an embodiment of the present disclosure.

FIG. 2 is a diagram for explaining a configuration of a base material attached to a rotary device according to an embodiment of the present disclosure.

FIG. 3 is a diagram showing an example of a flow path of a liquid arranged in a base material.

FIG. 4 is a diagram for explaining a configuration of a liquid supply device.

FIG. 5 is a graph showing the progress of a temperature of a base material back surface and temperatures of an inlet and an outlet of a flow path arranged in a base material in Example 1.

### DESCRIPTION OF EMBODIMENTS

The properties of a film formed by thermal spray are greatly affected by the conditions at the time of film formation. One of the conditions is the temperature of a base material on which the film is formed. In a thermal spray process, the film-forming material in a molten state or a semi-molten state is sprayed, so that the base material becomes hot. When the thermal spray is completed, the temperature of the base material decreases. When the temperature of the base material decreases, thermal stress is generated in the base material, causing problems such as the film peeling off from a surface of the base material, and cracks occurring in the film.

According to an embodiment of the present disclosure, it is possible to provide a rotary device and a thermal spraying apparatus capable of reducing thermal stress of a base material and preventing peeling of the film from the base material and cracking of the film.

Hereinafter, embodiments of the present disclosure will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but are merely examples, and do not limit the interpretation of the present disclosure.

In the drawings, the widths, thicknesses, shapes, and the like of the respective portions may be schematically represented in comparison with the actual embodiments for clarity of explanation, but the drawings are merely examples, and do not limit the interpretation of the present invention. Furthermore, in the present specification and the drawings, elements having the same functions as those described with respect to the above-described drawings are denoted by the same reference signs, and redundant descriptions thereof may be omitted. Furthermore, in the present specification and the drawings, the same or similar parts are denoted by the same reference signs or similar reference signs (reference signs denoted by A, B, and the like after numerals) and repeated description thereof may be omitted.

In the present specification, in the case where a member or region is “above (or below)” another member or region, it includes the case where it is directly above (or below) the other member or region, but also the case where it is above (or below) the other member or region, that is, the case where another component is included between above (or below) the other member or region.

Furthermore, in the present specification, the expressions “a includes A, B or C,” “a includes any of A, B and C,” and “a includes one selected from a group consisting of A, B, and C” do not exclude the case where a includes a plurality of combinations of A to C unless otherwise specified. Furthermore, these expressions do not exclude the case where a includes other elements.

Hereinafter, a thermal spraying apparatus 10 according to an embodiment of the present disclosure will be described with reference to the drawings.

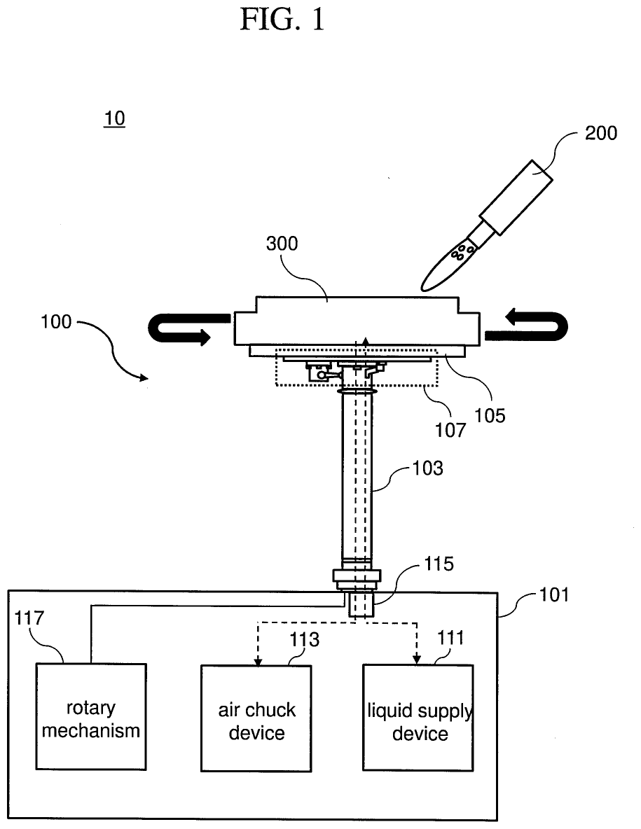

FIG. 1 is a diagram for explaining a configuration of the thermal spraying apparatus 10 according to an embodiment of the present disclosure. The thermal spraying apparatus 10 includes a rotary device 100 that supports a base material 300, and a thermal spray gun 200 that sprays a thermal spray material onto a surface of the base material 300.

The rotary device 100 includes a frame 101, a rotary support 103, a rotary stage 105, a liquid supply device (liquid supply unit) 111, an air chuck device 113, and a rotary mechanism 117.

The liquid supply device 111, the air chuck device 113, and the rotary mechanism 117 are installed on the frame 101. The frame 101 may be a housing.

The liquid supply device 111 supplies a liquid adjusted to a predetermined temperature range to the base material 300. In addition, the liquid supply device 111 collects the liquid circulated through the base material 300, and adjusts the collected liquid again to the predetermined temperature range. The liquid supply device 111 supplies the liquid to the base material 300 and collects the liquid from the base material 300 through pipes (not shown) arranged in the rotary stage 105 and the rotary support 103. The pipes may be a hollow-path arranged in the rotary stage 105 and the rotary support 103. A detailed configuration of the liquid supply device 111 will be described later.

The rotary mechanism 117 is connected to the rotary support 103, which will be described later. The rotary mechanism 117 includes a driving device such as a motor. The rotary mechanism 117 rotates the rotary stage 105, which is fixed to the rotary support 103, around the rotary support 103 as an axis.

The air chuck device 113 vacuum-chucks the base material 300 formed at least in part of a porous material through a pipe (suction pipe, not shown) arranged in the rotary stage 105 and the rotary support 103, and fixes the base material 300 on the rotary stage 105. The pipe may be a hollow-path arranged in the rotary stage 105 and the rotary support 103. The air chuck device 113 may include a vacuum pump connected to the pipe arranged in the rotary support 103.

The rotary support 103 supports the rotary stage 105, which will be described later. Although not shown, a pipe (first pipe) for supplying a liquid from the liquid supply device 111 to the base material 300, a pipe (second pipe) for collecting the liquid circulated through the base material 300 to the liquid supply device 111, and a pipe (suction pipe) connected to the air chuck device 113 are arranged inside the rotary support 103. These pipes may be hollow passes arranged inside the rotary support 103. The first pipe, the second pipe, and the suction pipe arranged inside the rotary support 103 are connected to the liquid supply device 111 and the air chuck device 113 via a rotary joint 115, respectively.

The rotary support 103 is connected to the rotary mechanism 117. The rotary support 103 functions as a shaft, and is capable of rotating the rotary stage 105 and the base material 300 mounted on the rotary stage 105 around the long axis direction of the rotary support 103.

The rotary support 103 may have a connecting portion 107 connected to the rotary stage 105. The connecting portion 107 may be connected to a position control mechanism such as an actuator. In this case, the connecting portion 107 can tilt the rotary stage 105 and the base material 300 mounted on the rotary stage 105 at a predetermined angle relative to the thermal spray gun 200.

The rotary stage 105 is fixed to the rotary support 103. The rotary stage 105 may be fixed to the rotary support 103 to be tiltable. The rotary stage 105 detachably supports the base material 300. In a thermal spray process, the rotary stage 105 rotates together with the base material 300 by the rotary support 103 connected to the rotary mechanism. In this case, the rotary stage 105 may be tilted at a predetermined angle relative to the thermal spray gun 200 that sprays the thermal spray material onto the base material 300. Although not shown, a liquid supply port connected to a first pipe arranged in the rotary support 103 and supplying the liquid supplied through the first pipe to the base material 300, and a liquid discharge port connected to the second pipe arranged in the rotary support 103 and discharging the liquid circulated through the base material 300 are arranged in the rotary stage 105. The liquid supply port is arranged to be aligned with the first pipe and an inlet (303) arranged in the base material 300 described later. Similarly, the liquid discharge port is arranged to be aligned with the second pipe and an outlet (305) arranged in the base material 300 described below.

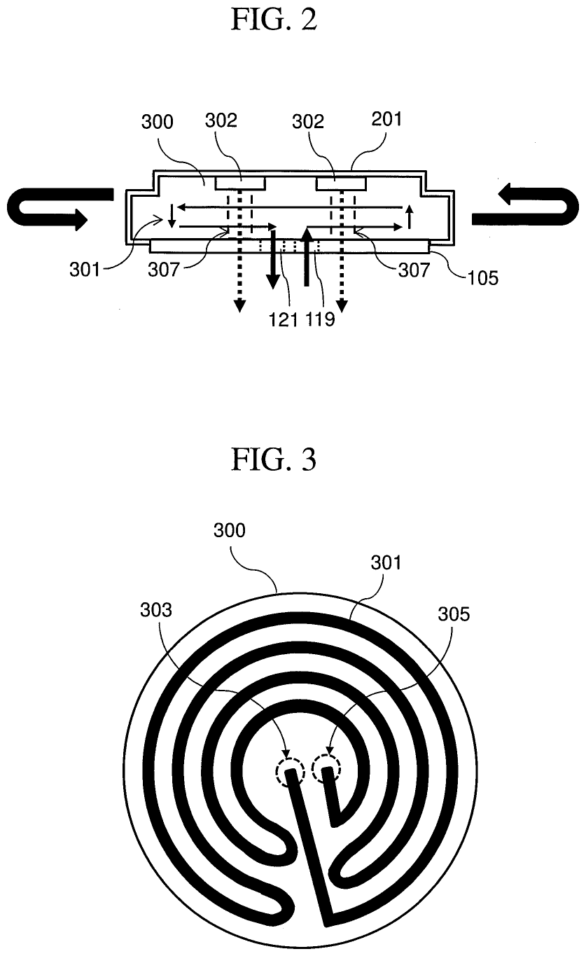

FIG. 2 is a diagram for explaining a configuration of the base material 300. The base material 300 is mounted on the rotary stage 105 of the rotary device 100. For example, the base material 300 includes a metal material such as aluminum (Al). A thermal spray film 201 is formed on the base material 300 by the thermal spray material sprayed from the thermal spray gun 200. As shown in FIG. 2, a flow path 301 for circulating the liquid supplied from the liquid supply device 111 is arranged inside the base material 300.

FIG. 3 is a diagram showing an example of the flow path 301 arranged in the base material 300. FIG. 3 is a diagram of the base material 300 viewed from the back surface side where the thermal spray film 201 is not formed. The flow path 301 includes an inlet 303 that receives the supply of the liquid from the liquid supply device 111, and an outlet 305 that returns the liquid circulated in the base material 300 along the flow path 301 to the liquid supply device 111. The inlet 303 is connected to a liquid supply port 119 (see FIG. 2) arranged in the rotary stage 105 and connected to the first pipe arranged in the rotary support 103. The outlet 305 is connected to a liquid discharge port 121 (see FIG. 2) connected to the second pipe arranged in the rotary support 103. In the case where the base material 300 is circular, as shown in FIG. 3, the flow path 301 is preferably arranged in the entire base material 300 along the circumferential direction of the base material 300. Although the case where the base material 300 is circular is shown in FIG. 3, the shape of the base material 300 is not limited to a circular shape.

At least a portion of the base material 300 is formed of a porous material 302. For example, the porous material 302 may be a porous ceramic with a pore size of 10 to 200 μm. A through hole 307 connected to the suction pipe arranged in the rotary support 103 and connected to the air chuck device 113 may be arranged inside the base material 300. The through hole 307 connects to the porous material 302 portion of the base material 300. In addition, the base material 300 of the present embodiment is not limited to this, and the base material 300 may not include a porous material. In this case, the base material 300 can be fixed to the rotary stage 105 by a fixing tool such as a screw.

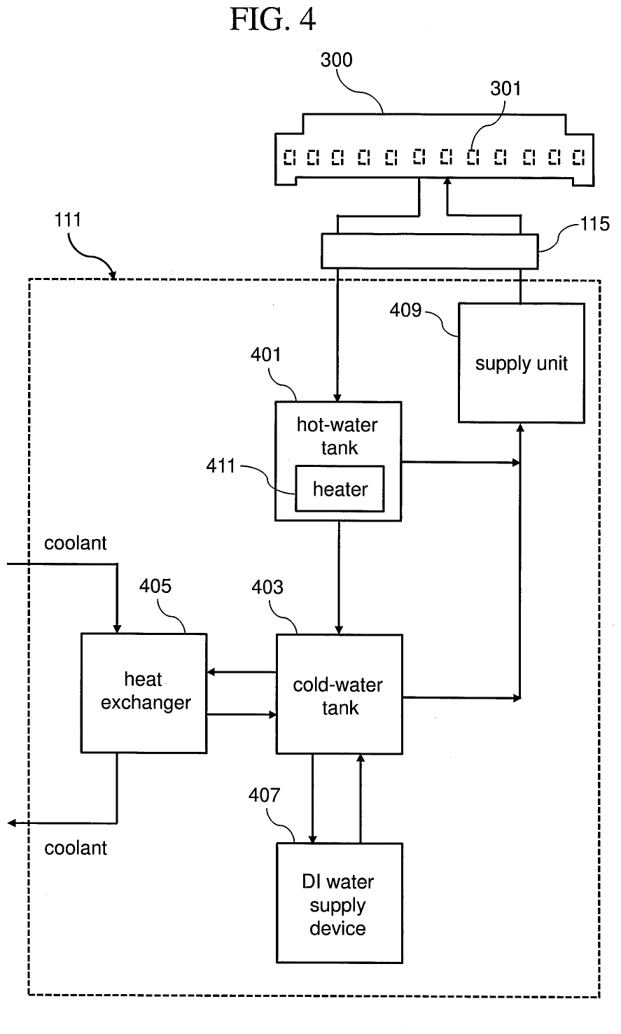

The liquid supply device 111 supplies a liquid at a predetermined temperature to the base material 300 mounted on the rotary stage 105. Hereinafter, a configuration of the liquid supply device 111 will be described with reference to FIG. 4.

FIG. 4 is a diagram for explaining the configuration of the liquid supply device 111. The liquid supply device 111 includes a hot-water tank 401, a cold-water tank 403, a heat exchanger 405, a DI water supply device 407, and a supply unit 409. In the present embodiment, an example in which water is used as a liquid used for adjusting the temperature of the base material 300 will be described. The rotary support 103 and the rotary stage 105 are not shown in FIG. 4.

The hot-water tank 401 temporarily stores hot water to be supplied to the base material 300. The hot water stored in the hot-water tank 401 is maintained at a temperature of about 20° C. to 120° C. The hot-water tank 401 has a heater 411 for maintaining the temperature of the stored hot water. The hot-water tank 401 supplies hot water to the supply unit 409. The hot-water tank 401 collects the liquid circulated through the base material 300, and supplies a portion of the liquid to the cold-water tank 403. The liquid circulated through the base material 300 is collected in the hot-water tank 401 via the liquid discharge port arranged in the rotary stage 105 and the second pipe arranged in the rotary support 103. The hot-water tank 401 is connected to the second pipe arranged in the rotary support 103 via the rotary joint 115, and collects the liquid circulated through the base material 300 via the rotary joint 115.

The cold-water tank 403 temporarily stores cold water to be supplied to the base material 300. The cold water stored in the cold-water tank 403 is maintained at a normal temperature (about 20° C. to about 35° C.). The cold-water tank 403 supplies cold water to the supply unit 409. In addition, the cold-water tank 403 receives the supply of hot water from the hot-water tank 401. The cold-water tank 403 supplies water including the supplied hot water to the heat exchanger 405. Cold water is supplied to the cold-water tank 403 from the heat exchanger 405. In addition, the cold-water tank 403 may supply the stored cold water to the DI water supply device 407.

Water is supplied to the heat exchanger 405 from the cold-water tank 403. The heat exchanger 405 cools the supplied water and returns the cooled water to the cold-water tank 403. The heat exchanger 405 may be a radiator.

The DI water supply device 407 purifies the water supplied from the cold-water tank 403. The DI water supply device 407 includes an ion exchange resin. The DI water supply device 407 returns the water purified by the ion exchange resin to the cold-water tank 403. According to an embodiment, the DI water supply device 407 may be omitted from the configuration of the liquid supply device 111.

Hot water is supplied from the hot-water tank 401 and cold water from the cold-water tank 403 to the supply unit 409. The supply unit 409 mixes the supplied hot water and cold water to adjust the hot water to a predetermined temperature, and supplies the hot water to the base material 300 via the first pipe arranged in the rotary support 103 and the liquid supply port arranged in the rotary stage 105. The temperature of the hot water to be adjusted in the supply unit 409 is preferably in a range of 85° C. or higher and 120° C. or lower. The supply unit 409 is connected to the first pipe arranged in the rotary support 103 via the rotary joint 115, and supplies the temperature-adjusted hot water to the base material 300 via the rotary joint 115.

The supply unit 409 may include a pressurizing device. In the case where the temperature of the hot water supplied to a base material 109 is adjusted to be higher than 100° C., the temperature of the hot water can be adjusted to be higher than 100° C. by pressurizing the hot water with the pressurizing device.

If the temperature difference between the base material 300 during the thermal spray process in which the thermal spray material in a molten state or a semi-molten state is sprayed from the thermal spray gun 200 and after the thermal spray is completed is large, there is a possibility that a thermal stress is generated in the base material 300, the thermal spray film 201 is peeled off from the surface of the base material 300, or cracks occur in the thermal spray film 201.

In the present embodiment, hot water adjusted to a predetermined temperature is supplied from the liquid supply device 111 to the base material 300. The hot water supplied to the base material 300 circulates through the entire base material 300 along the flow path 301 formed in the base material 300. The hot water flowing through the flow path 301 receives heat from the base material 300 which becomes hot during the thermal spray process, and suppresses the temperature rise of the base material 300. That is, the hot water supplied to the base material 300 functions as a heat medium. Therefore, the temperature difference between the base material 300 during the thermal spray process and after the thermal spray process is reduced, and the thermal stress generated in the base material 300 can be reduced. As a result, it is possible to prevent peeling of the thermal spray film and the occurrence of cracks. In addition, the temperature fluctuation of the base material 300 during the thermal spray process is reduced, and the residual stress in the thermal spray film to be formed is also reduced. As a result, the peeling resistance of the thermal spray film is improved, the variation in the quality of each individual product is reduced, and the reliability of the product manufactured by the thermal spraying apparatus 10 is improved.

In the above embodiment, the example in which water is used as the liquid supplied from the liquid supply device 111 to the base material 300 has been described. However, the liquid used to adjust the temperature of the base material 300 is not limited to water. For example, a high boiling point material such as Galden or other liquid mediums may be used to adjust the temperature of the base material 300. In this case, the temperature of the liquid medium supplied from the liquid supply device 111 to the base material 300 is preferably in a range of 25° C. or higher and 270° C. or lower. The configuration of the liquid supply device 111 can be changed as appropriate depending on the type of the heat medium used to adjust the temperature of the base material 300.

### EXAMPLES

### Example 1

The temperature of the base material in the case where the rotary device according to an embodiment of the present disclosure is used is verified. A configuration of the rotary device used is the same as the configuration of the rotary device 100 described with reference to FIG. 1. In addition, a configuration of the liquid supply device included in the rotary device used is the same as the configuration of the liquid supply device 111 described with reference to FIG. 4. A configuration of the base material used is the same as the configuration of the base material 300 described with reference to FIG. 2 and FIG. 3. The main body was aluminum and the porous part 302 was used as the base material 300 made of aluminum oxide.

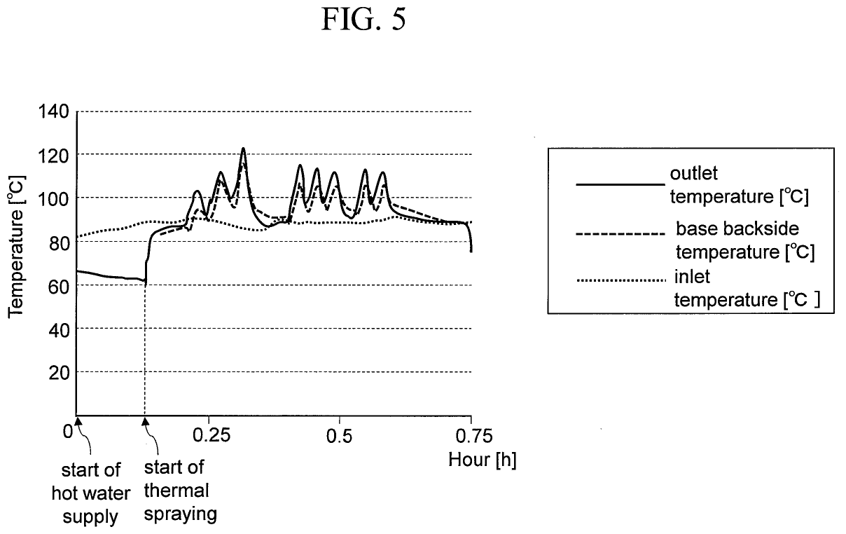

In Example 1, the temperature of the hot water supplied into the base material from the liquid supply device was set to 85° C., a water supply pressure from the liquid supply device to the base material was set to 3 atmospheres, and the temperature of the back surface side of the base material during the thermal spray process (the surface on which the thermal spray film is not formed) and the temperatures of an inlet and an outlet of the flow path arranged in the base material were measured. The thermal spray material sprayed from the thermal spray gun 200 onto the base material surface during the thermal spray process is aluminum oxide and its temperature is 1800° C. to 2500° C. FIG. 5 shows the temperature of the base material back surface in Example 1 and the temperature of the inlet and the outlet of the flow path arranged in the base material.

Referring to FIG. 5, in Example 1 using the rotary device according to the embodiment of the present disclosure, when hot water set to 85° C. is supplied from the liquid supply device to the base material, the back surface temperature of the base material back surface during the thermal spray process is maintained at about 105° C. In addition, the temperature of the inlet of the flow path was about 85° C., while the temperature of the outlet was about 110° C. This means that the hot water circulating in the flow path receives the heat from the surface side of the base material on which the thermal spray film is formed during the thermal spray process, and suppresses the temperature rise of the base material. This result suggests that the temperature difference between the base material during the thermal spray process and after the thermal spray process is reduced in Example 1. Therefore, it can be seen that the temperature of the base material during the thermal spray process can be effectively adjusted by using a liquid as the heat medium.

As described above, by the rotary device according to the embodiment of the present disclosure, it is possible to suppress the temperature rise of the base material during the thermal spray process and reduce the temperature difference between the base material during the thermal spray process and after the thermal spray process. As a result, the thermal stress generated in the base material can be reduced, and as a result, the thermal spray film can be prevented from being peeled off from the base material after the thermal spray process and the occurrence of cracks in the thermal spray film can be prevented, the quality of the thermal spray film can be improved, and the reliability of the product can be improved. In addition, since the thermal stress generated during the thermal spray process is small, the quality of the base material including the thermal spray film is improved, and the reliability of the base material is improved when the base material is actually used.

### Modification

In the embodiment of the present disclosure described above, although the case where the liquid is supplied from the liquid supply device 111 to the base material 300 provided on the rotary device 100 has been described, the present disclosure is not limited to this. For example, a pressurized gas may be supplied from a gas supply device (gas supply unit) to the base material 300.

In the thermal spraying apparatus according to the modification of the present disclosure, the rotary device 100 may include the gas supply device in addition to the liquid supply device 111. For example, the gas supply device may supply water vapor as a pressurized gas to the base material 300. In this case, the gas supply device can be configured substantially in the same manner as the configuration of the liquid supply device 111 shown in FIG. 4, except that the hot-water tank (the hot-water tank 401 in FIG. 4) is omitted, and instead, the cold water supplied from the cold-water tank (the cold-water tank 403 in FIG. 4) is heated to generate steam by a boiler and supplied to the base material 300. In addition, the steam generated by the boiler may be mixed with hot air before being supplied to the base material 300 to adjust the temperature. Furthermore, the gas supplied from the gas supply device is not limited to water vapor. For example, the gas supply device supplies a gas of about 85° C. to about 145° C.

The gas supply device may supply pressurized gas to the base material 300 before the thermal spray process. The gas supply device can efficiently adjust the temperature of the base material 300 by supplying the pressurized gas to the base material 300 before the start of thermal spray.

By adjusting the temperature of the base material 300 to a desired temperature by the gas supplied from the gas supply device before the start of thermal spraying, it is possible to prevent the temperature of the base material 300 from suddenly rising after the start of thermal spraying, and to reduce the thermal stress generated in the base material 300 before and after the start of thermal spraying. Furthermore, in order to adjust the temperature of the base material 300 during the thermal spray process, after the start of thermal spraying, that is, during the thermal spray process, the rotary device 100 preferably receives the supply of hot water as a heat medium from the liquid supply device 111 according to the above-described embodiment.

As described above, the rotary device 100 may adjust the base material 300 to a desired temperature by receiving the supply of gas from the gas supply device before the start of thermal spraying, and may adjust the base material 300 on which the thermal spray film is formed to a desired temperature by receiving the supply of hot water from the liquid supply device 111 after the start of thermal spraying (during the thermal spray process). In this case, in the rotary device 100, the connection between the gas supply device and the liquid supply device 111 and the rotary joint 115 may be switched between before the start of thermal spraying and after the start of thermal spraying.

The addition, deletion, or design change of components as appropriate by those skilled in the art based on the embodiment and modification are also included in the scope of the present invention as long as they are provided with the gist of the present invention.

In the embodiment of the present disclosure described above, although the case where the rotary device includes the liquid supply device has been described, the present disclosure is not limited to this. For example, in a device that performs a process of being heated to about 200° C. in addition to the rotary device used for the thermal spraying, the liquid supply device of the present embodiment may be applied to control the temperature of the base material.

Furthermore, it is understood that, even if the effect is different from those provided by each of the above-described embodiments, the effect obvious from the description in the specification or easily predicted by persons ordinarily skilled in the art is apparently derived from the present invention.

What is claimed is:

1. A rotary device comprising:
a rotary stage detachably supporting a base material having an inlet, an outlet, and a flow path connecting the inlet and the outlet of a liquid at a predetermined temperature, the rotary stage having a liquid supply port supplying the liquid to the base material and a liquid discharge port discharging the liquid from the base material;
a rotary support supporting the rotary stage, the rotary support having a first pipe connected to the liquid supply port and a second pipe connected to the liquid discharge port inside;
a rotary mechanism rotating the rotary stage around the rotary support; and
a liquid supply part supplying the liquid to the base material.

2. The rotary device according to claim 1, wherein:
the rotary support is connected to the rotary stage at one end and supports an opposite side of a surface of the rotary stage on which the base material to be placed; and
when the base material is placed on the rotary stage, the rotary stage and the base material rotate together with the rotary support.

3. The rotary device according to claim 1, wherein, when the base material is placed on the rotary stage, the liquid supply port is connected to the inlet, and the liquid discharge port is connected to the outlet.

4. The rotary device according to claim 1, wherein the liquid supply part comprises:
a hot-water tank supplying hot-water at a relatively high temperature;
a cold-water tank supplying cold-water at a relatively low temperature; and
a supply unit mixing the hot-water supplied from the hot-water tank and the cold-water supplied from the cold-water tank, adjusting the mixed water to a predetermined temperature, and supplying the water to the base material.

5. The rotary device according to claim 4, wherein the liquid supply part further comprises a pressurizing device pressurizing the water adjusted to the predetermined temperature.

6. The rotary device according to claim 1, wherein the liquid supply part further comprises a heat exchanger providing room temperature water to the cold-water tank.

7. The rotary device according to claim 1, wherein the predetermined temperature is in a range of 85° C. or higher and 120° C. or lower.

8. The rotary device according to claim 1, wherein the predetermined temperature is in a range of 25° C. or higher and 270° C. or lower.

9. The rotary device according to claim 1, wherein the liquid supply part supplies the liquid to the base material via the first pipe and collects the liquid from the base material via the second pipe while the rotary stage is rotating.

10. The rotary device according to claim 9, wherein the first pipe is connected to the liquid supply part via a rotary joint.

11. The rotary device according to claim 1, wherein the liquid supply port is arranged to be aligned with the inlet and the liquid discharge port is arranged to be aligned with the outlet.

12. The rotary device according to claim 1, further comprising:
a chuck mechanism holding the base material on the rotary stage.

13. The rotary device according to claim 12, wherein the chuck mechanism is a vacuum chuck mechanism, and the vacuum chuck mechanism comprises:
a through hole arranged in the rotary stage,
a suction pipe arranged in the rotary support and connected to the through hole; and
a vacuum pump connected to the suction pipe.

14. The rotary device according to claim 13, wherein at least a portion of the base material contains a porous material.

15. The rotary device according to claim 13, wherein the suction pipe is connected to the vacuum pump via a rotary joint.

16. A thermal spraying apparatus comprising:
the rotary device according to claim 1, and
a thermal spray gun.

17. The thermal spraying apparatus according to claim 16, wherein
the thermal spray gun sprays a thermal spray material onto a surface of the base material supported by the rotary stage; and
the liquid supply part supplies the liquid to the base material while the thermal spray material is sprayed from the thermal spray gun.

18. The thermal spraying apparatus according to claim 17, wherein the rotary device further comprises a gas supply unit supplying a pressurized gas to the base material, and the gas supply unit supplies the pressurized gas to the base material before the thermal spray material is sprayed from the thermal spray gun.
